(19) United States
(12) Patent Application Publication
(10) Pub. No.: US 2025/0111714 A1
(43) Pub. Date: Apr. 3, 2025

(54) VEHICULAR SENSOR CALIBRATING AND TESTING SYSTEM

(71) Applicant: BPG Sales and Technology Investments, LLC, Ada, MI (US)

(72) Inventor: David M. DeBoer, Grand Rapids, MI (US)

(21) Appl. No.: 18/901,676

(22) Filed: Sep. 30, 2024

Related U.S. Application Data
(60) Provisional application No. 63/586,044, filed on Sep. 28, 2023.

(51) Int. Cl. G07C 5/08; G01S 7/40; G01S 7/497; G01S 7/52

(52) U.S. Cl. CPC G07C 5/0808; G01S 7/40; G01S 7/497; G01S 7/52004

(57) ABSTRACT

A system and method of calibrating sensors of a vehicle includes providing a plurality of targets for calibration of sensors of equipped vehicles from a plurality of vehicle categories, where each vehicle category defines locations of at least one sensor on a vehicle of the vehicle category, orienting a vehicle into a reference position on a vehicle platform, and moving the vehicle based on the vehicle category of the oriented vehicle to align the plurality of targets with the sensors for calibrating the sensors.

### CROSS REFERENCE TO RELATED APPLICATION

The present application claims the priority benefit of U.S. provisional patent application Ser. No. 63/586,044, filed on Sep. 28, 2023, which is incorporated herein by reference in its entirety.

### TECHNICAL FIELD AND BACKGROUND

The present invention is directed to a vehicle sensor calibrating and testing system, and in particular to a method and system for aligning a vehicle having ADAS sensors and one or more calibration targets for calibration and/or testing of the sensors.

The use of radar, imaging systems, and other sensors, such as LIDAR, ultrasonic, and infrared (IR) sensors, to determine range, velocity, and angle (elevation or azimuth) of objects in an environment are important in a number of automotive safety systems, such as an Advanced Driver Assistance System (ADAS) for a vehicle. A conventional ADAS system will utilize one or more sensors. While these sensors are aligned and/or calibrated by the manufacturer during production of the vehicle whereby they are able to provide accurate driver assistance functionality, the sensors may need realignment or recalibration periodically, such as due to the effects of wear and tear, or misalignment due to driving conditions or through mishap, such as a collision. However, given the wide range of vehicle body types and sizes, the sensors are located in different locations on each vehicle and, hence, require multiple set ups for each vehicle. Further, in the case of autonomous vehicles, the number of sensors may vary considerable—with autonomous vehicles having a large number of sensors and requiring an even larger number of set ups over conventional vehicles. In addition, given that many of their sensors control driving of the car they may need to be calibrated more frequently than conventional vehicles.

### SUMMARY

The present disclosure provides a method and system for calibrating and/or testing sensors of a vehicle using a plurality of calibration targets that are arranged and located for calibrating and/or testing one or more sensors of a designated vehicle of a plurality of different vehicles.

The system provides a plurality of calibration targets that may be fixed or moveable, such as in a vehicle bay. In one embodiment a vehicle is positioned on a vehicle centering system that orients the vehicle in a known position for calibration and/or testing of the vehicle sensors, such as ADAS sensors of the vehicle. The system may further comprise a vehicle turntable on which the centering system is disposed. Depending on the vehicle under test, the turntable may rotate the vehicle upon being centered whereby the vehicle is oriented with respect to targets applicable to the vehicle under test. The plurality of targets may thus include targets for various makes, models and years of vehicles with the system being operable to rotate the vehicle under test into the orientation with the targets applicable for calibrating or testing the sensors thereof, whereby the system is configured to accommodate multiple vehicles by make and/or model. In another embodiment, the plurality of targets may be moveable about a vehicle disposed in a known orientation to position the appropriate targets relative to the vehicle under test. The targets may again include ones for various makes, models and/or years, with the targets moved into alignment with the sensors and coordinate system of the vehicle under test. In yet a further embodiment, the system may be configured as a dynamic vehicle test (DVT) stand to enable dynamic sensor calibration and/or testing. In a particular embodiment the dynamic vehicle test stand comprises a roll-brake machine, which may be incorporated on a turntable. Still further a vehicle centering system may be employed with the DVT in which the locating arms are inwardly projected from about the vehicle to contact and center the vehicle on the test stand.

In one embodiment, a method of calibrating sensors on a vehicle having a vehicle category, with the vehicle category defining the sensor locations on the vehicle. The method includes providing a plurality of calibration targets and locating the calibration targets in reference target locations based on the vehicle category. The method further includes locating the vehicle in a known reference vehicle location so that when the vehicle is in the known reference vehicle location the calibration targets are aligned with the sensors of the vehicle.

In another embodiment, a method of calibrating sensors on a plurality of different vehicles includes providing a plurality of calibration targets. A first vehicle, equipped with sensors, is aligned and located in a first known reference vehicle location relative to a first group of calibration targets of the plurality of calibration targets so that the sensors of the first vehicle are aligned with the first group of calibration targets to calibrate the sensors of the first vehicle. A second vehicle, equipped with sensors, is aligned and located in a second known reference vehicle location relative to a second group of calibration targets of the plurality of calibration targets so that the sensors of the second vehicle are aligned with the second group of calibration targets to calibrate the sensors of the second vehicle.

In any of the above, the first and second vehicle may be different categories of vehicle, such as different types of vehicles, different brands of vehicles, and/or different models of vehicles.

In one aspect, the plurality of calibration targets may be in fixed known target locations, and a respective vehicle of the first and second vehicles may be moved to its respective vehicle known reference vehicle location so that its sensors are aligned with its respective group of calibration targets. The vehicles may be moved by a turntable relative to the targets, which may be fixed. In a further aspect, the respective vehicle is first moved to a known initial vehicle location and then moved from its known initial vehicle location to its respective known reference vehicle location. The vehicle may be moved, such as by rotating the vehicle on a vehicle turntable.

Alternately, each respective vehicle may have a fixed known reference vehicle location, and a respective group of calibration targets of the first and the second group of calibration targets may be moved to known reference target locations to align and locate the respective calibration targets with sensors on the vehicle for calibrating the sensors of the respective vehicle. For example, the calibration targets may be moved by robotic arms.

In any of the methods, the coordinates of the known reference vehicle location for each vehicle is referenced to a component of the reference vehicle, such as the center of the front axle of the reference vehicle.

Further, after aligning and locating the first vehicle in the first known reference vehicle location relative to the first group of calibration targets, the first group of calibration targets calibrate the sensors of the first vehicle. Similarly, after the first vehicle is removed from the system and after aligning and locating the second vehicle in the second known reference vehicle location relative to the second group of calibration targets, the second group of calibration targets calibrate the sensors of the second vehicle.

In any of the above, the first and second vehicle may be different categories of vehicle, such as different types of vehicles, different brands of vehicles, and/or different models of vehicles.

According to another embodiment, a vehicle testing and calibration system for calibrating sensors on a vehicle includes a target positioning system and a vehicle bay for receiving a vehicle equipped with sensors. The vehicle has a vehicle category associated therewith, which defines the location of the sensors on the vehicle, and a known reference vehicle location. The target positioning system includes a plurality of calibration targets that are arranged in a defined space at known fixed target locations based on the vehicle category of the vehicle so that the calibration targets align with the sensors of the vehicle when the vehicle is located in the known reference vehicle location in the vehicle bay.

According to another embodiment, a system for dynamically calibrating sensors on a vehicle includes a target positioning system and a vehicle bay for receiving a vehicle equipped with sensors. The target positioning system includes a plurality of calibration targets that are arranged in a defined space at known fixed target locations. The vehicle bay is configured to receive a vehicle in a known initial vehicle location in the vehicle bay. The system further includes a computer system that is configured to determine the known reference vehicle location associated with the vehicle and then selectively control movement of the vehicle in the vehicle bay to the known reference vehicle location, which aligns the sensors of the vehicle with at least a first group of calibration targets wherein the first group of calibration targets is operable to calibrate the sensors of the vehicle.

According to another embodiment, a system for dynamically calibrating sensors on a plurality of different vehicles includes a target positioning system and a vehicle bay for receiving a vehicle equipped with sensors. The calibration target positioning system includes a plurality of calibration targets that are arranged in a defined space at known fixed target locations. The vehicle bay is configured to receive a vehicle in a known initial vehicle location in the vehicle bay. The system further includes a computer system that is configured to determine the known reference vehicle location associated with the vehicle and then selectively control movement of the vehicle in the vehicle bay and to move vehicle to the known reference vehicle location, which aligns the sensors of the vehicle with a first group of calibration targets wherein the first group of calibration targets is operable to calibrate the sensors of the vehicle.

In a further aspect, the vehicle bay is configured to receive a second vehicle and further to receive the second vehicle in the known initial location. The computer system is configured to determine the second known reference vehicle location associated with the second vehicle and then selectively control movement of the second vehicle in the vehicle bay to the second known reference, which aligns the sensors of the second vehicle with a second group of calibration targets wherein the second group of calibration targets is operable to calibrate the sensors of the second vehicle.

In a further aspect, the vehicle bay has a vehicle turntable that is controlled by the control system to rotate the respective vehicle from the known initial location to the respective known reference vehicle location.

According to yet another embodiment, a system for dynamically calibrating sensors on a plurality of different vehicles includes a target positioning system and a vehicle bay for receiving a vehicle equipped with sensors. The target positioning system includes a plurality of calibration targets that are arranged in a defined space. The vehicle bay is configured to receive a vehicle in a known reference vehicle location. The system further includes a computer system having stored therein a plurality of vehicle categories and a reference target location for each calibration target associated with each vehicle category, and said computer system being configured to determine the vehicle category of the vehicle located in the known vehicle location in the vehicle bay and to control the calibration target positioning system to move at least a group of calibration targets of said plurality of calibration targets to reference target locations associated with the vehicle category of the vehicle so that the group of calibration targets align with the sensors of the vehicle and are operable calibrate the sensors of the vehicle.

In one aspect, the vehicle bay is configured to receive a second vehicle (after the first vehicle has left the vehicle bay) and further to receive the second vehicle in the known reference location. The computer system is further configured to control the target positioning system to move a second group of calibration targets of the plurality of calibration targets to reference target locations associated with the vehicle category of the second vehicle so that the second group of calibration targets align with the sensors of the second vehicle and are operable calibrate the sensors of the second vehicle. For example, the calibration targets may be moved to their respective known reference target locations by robotic arms.

In any of the above systems, the coordinates of the known reference vehicle location for each vehicle is tied to a component of the reference vehicle, such as the center of the front axle of the reference vehicle.

The present invention provides a system and method for accurately positioning a vehicle having sensors relative to a group of calibration targets for a variety of vehicles and calibrating the sensors, such as in accordance with OEM specifications. The dynamic system and method provides for a quick and accurate calibration of the sensors of various vehicles. These and other objects, advantages, purposes and features of this invention will become apparent upon review of the following specification in conjunction with the drawings.

### BRIEF DESCRIPTION OF THE DRAWINGS

FIG. 1 is a perspective view of a dynamic vehicle testing and calibration system;

FIG. 2A is an enlarged perspective view of a vehicle platform of the vehicle testing and calibration system of FIG. 1;

FIG. 2B is a top plan view of the vehicle centering system of the target alignment system of FIG. 1;

FIG. 2C is a perspective view of the vehicle centering system of FIG. 2B;

FIG. 2D is a side perspective view of the forward wheel assembly supports of the vehicle centering system of FIG. 2B;

FIG. 2E is a bottom plan view of the forward wheel assembly supports of the vehicle centering system of FIG. 2B;

FIG. 2F is a bottom plan view of the rearward wheel assembly supports of the vehicle centering system of FIG. 2B;

FIG. 3 is a perspective view of another embodiment of a vehicle platform of the vehicle testing and calibration system of FIG. 1; and

FIG. 4 is a side elevation view of the vehicle platform of FIG. 4.

### DESCRIPTION OF THE PREFERRED EMBODIMENTS

The present disclosure will now be described with reference to the accompanying figures, wherein the numbered elements in the following written description correspond to like-numbered elements in the figures.

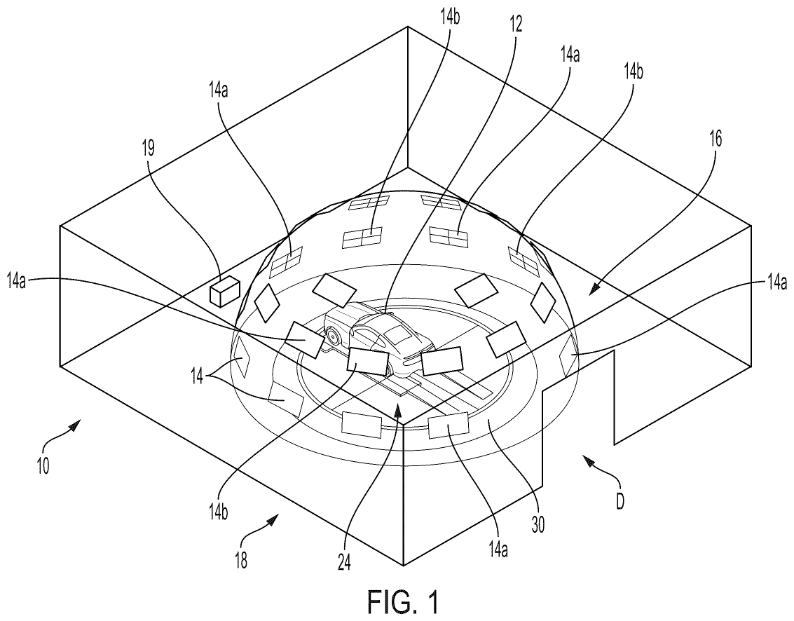

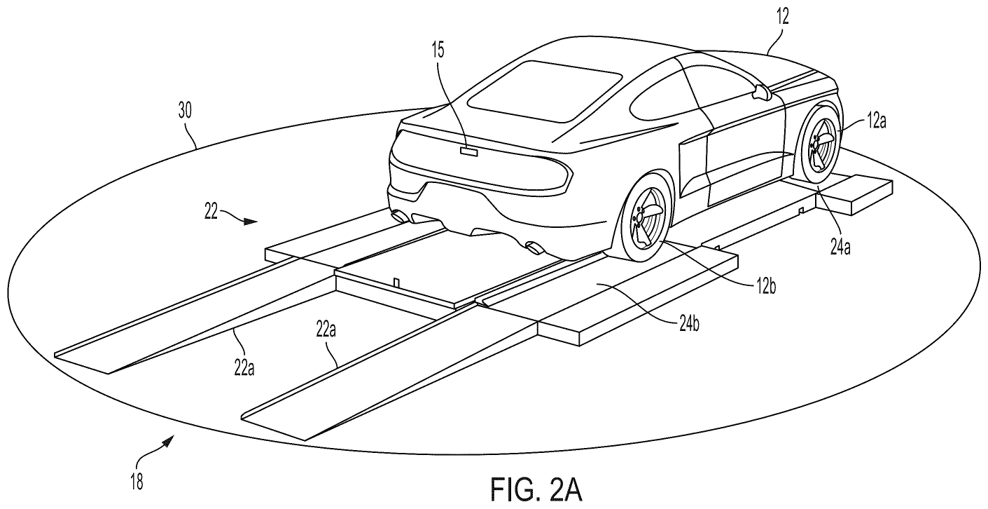

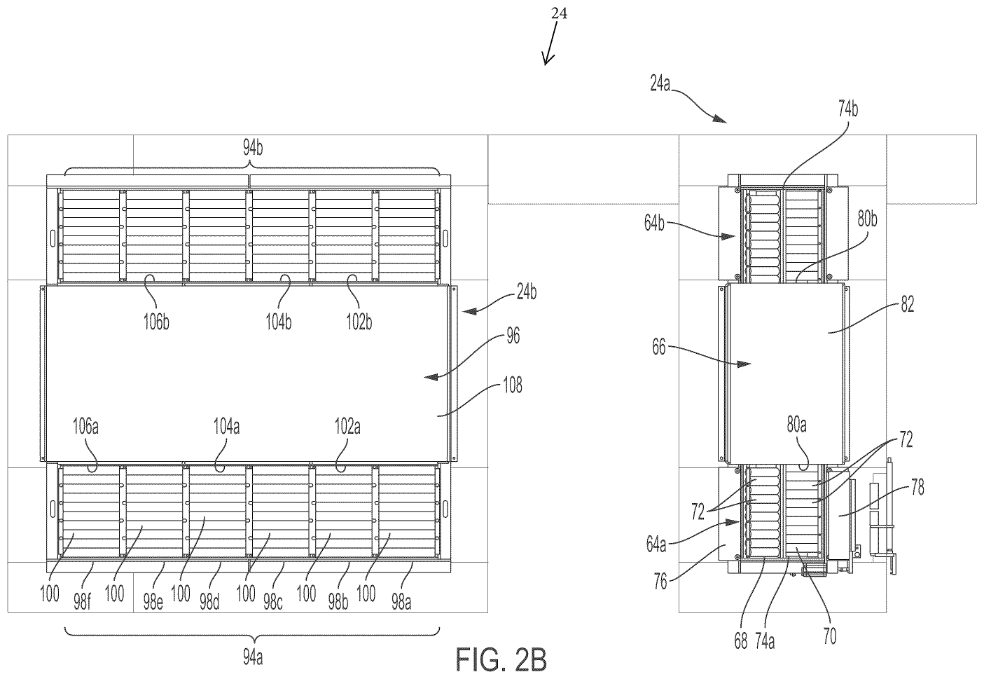

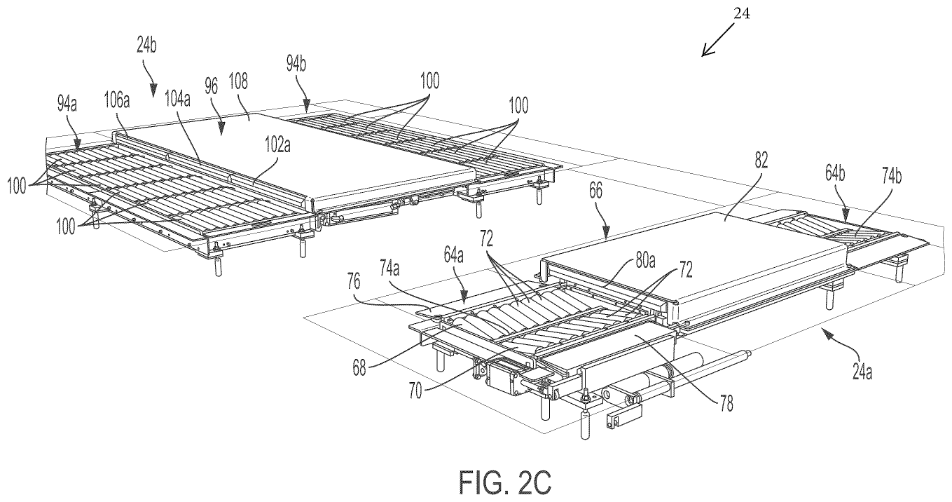

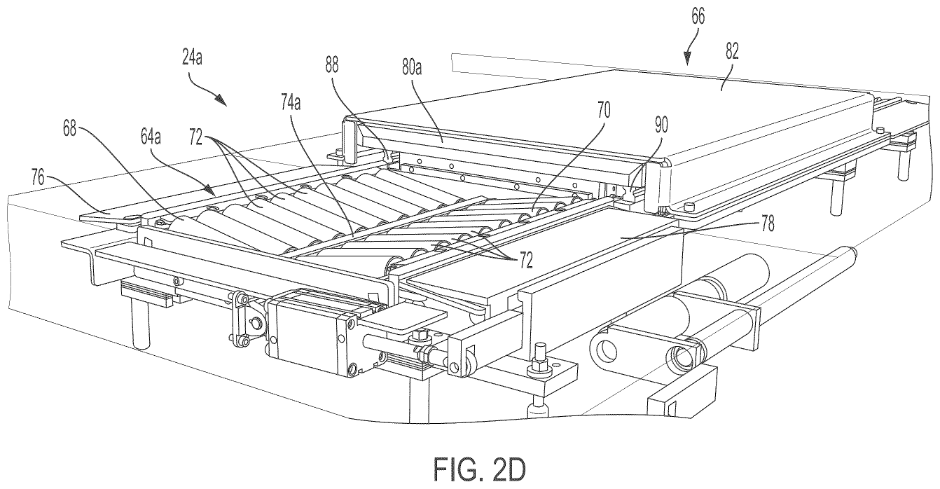

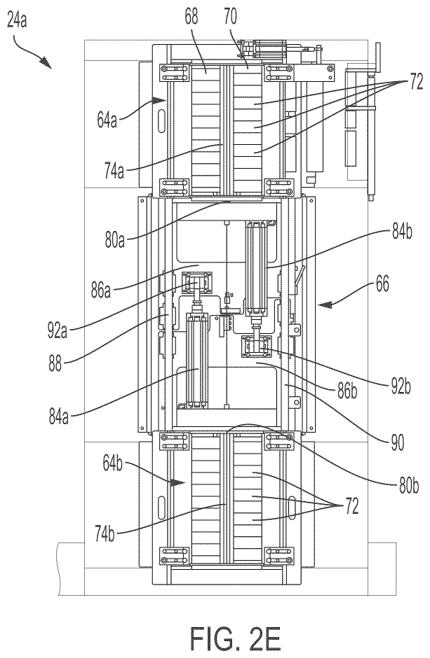

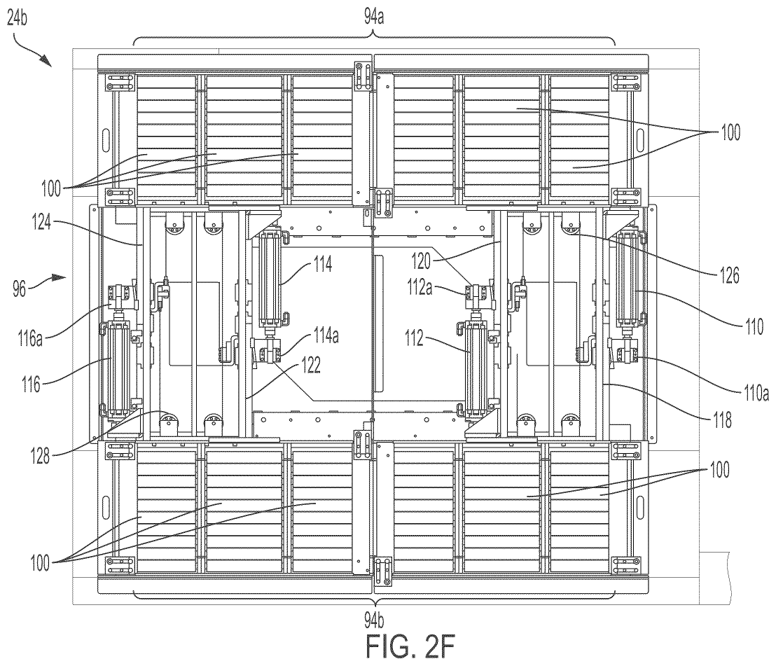

Referring to FIG. 1, the numeral 10 generally designates a vehicle testing and calibration system that is configured to calibrate multiple sensors on a vehicle 12 (FIG. 2) using calibration targets 14, where the sensors may include cameras, such as forward facing cameras, rear facing cameras, side view cameras, surround view camera systems, or may include radar sensors, lidar sensors, sonar/ultrasound sensors, or the like. Calibration targets 14 are constructed for use in calibration and/or testing of the sensors, such as in accordance with OEM specifications. The vehicle may be a conventional vehicle or an autonomous vehicle, which tend to have far more sensors than conventional vehicles. As will be more fully described below, the calibration targets 14 are each located relative to a known reference vehicle location of the vehicle 12 to align with the sensors of the vehicle 12 when the vehicle is located and aligned in the known reference vehicle location. Optionally, as described in reference to FIGS. 4 and 5, vehicle testing and calibration system 10 may incorporate other testing equipment, such as a dynamic vehicle testing apparatus.

In the illustrated embodiment, vehicle testing and calibration system 10 includes a calibration target positioning system 16 and a vehicle bay 18 for receiving a vehicle 12 equipped with one or more sensors 15 (FIG. 2A). The vehicle 12 has a vehicle identity or category associated therewith, such as based on the type of vehicle, such as based on the make, model and/or year of the vehicle, and/or based on the vehicle identification number (VIN) of the vehicle, for example, which defines the type and locations of sensors 15 of the vehicle 12, for example, with reference to a fixed reference point on the vehicle, such as the center of the front axle of the vehicle. The type and location of targets 14 for calibration of the sensors 15 is also based on or defined by the vehicle identity. This includes what targets 14 are to be used for calibration of a given sensor 15 on vehicle 12 as well as where such target 14 is to be located relative to the vehicle 12 for calibration of the sensor 15. Although vehicle 12 is illustrated herein with a single sensor 15, it should be appreciated that a given vehicle 12 may have a plurality of sensors 15 installed in different locations about the vehicle 12 and that require different targets 14 for calibration thereof. Although referenced herein in connection with calibration it should also be understood that the present system and method may be used for purposes of confirming the proper operation of the sensors 15 without running an OEM calibration program on the sensors 15. In which case the calibration operates as a check or confirmation as to the proper operation of the sensor 15.

Information regarding the sensors 15 and location thereof on a vehicle 12, as well as the targets 14 and the location relative to the vehicle 12 needed for calibration of the given sensors 15 may be stored in the computer system, described below, based on the vehicle identity. The information may also be used as a reference to determine when the vehicle is in its known reference vehicle location and also to determine the known reference target location for the initial set up for each of the calibration targets 14 based on the sensor 15 locations on the vehicle 12. Once the calibration targets 14 are set up for a given vehicle identity, they may remain in their known reference target locations. Therefore, once the vehicle identity of a vehicle 12 is known, the locations of the sensors 15 on the vehicle 12 are known. Further, once the vehicle 12 is aligned and located in its known reference vehicle location, the location of the sensors 15 are aligned with their respective calibration targets 14 for that given vehicle 12.

In the illustrated embodiment, thus the calibration target positioning system 16 includes a plurality of calibration targets 14 that are arranged in a defined space at known fixed target locations relative to the vehicle bay 18, and in particular to a vehicle support platform 22, which are based on the vehicle identity or category of the vehicle 12. The known fixed target locations are, therefore, aligned with the sensors 15 of the vehicle 12 when the vehicle 12 is moved to its known reference vehicle location in the vehicle bay 18.

In the illustrated embodiment, and as best understood from FIG. 1, the calibration targets 14 may be arranged about a virtual dome or virtual hemispherical space about vehicle bay and hence relative to the respective vehicle 12. Therefore, the virtual dome may provide a Cartesian coordinate system within which the targets 14 are located at reference target locations for the sensors 15 of a vehicle 12. In particular, system 10 includes a plurality of targets 14 where subsets of those targets are used for calibration of sensors on particular vehicles based on the vehicle identity. For example, certain targets 14a may be used for calibration of sensors on a 2017 Subaru Forester, and other targets 14b may be used for calibration of sensors on a 2016 Nissan Rogue. As discussed in more detail below, a given vehicle 12 positioned on the vehicle support platform 22 may be moved by movement of the platform 22 so as to be in the proper orientation for calibration of its sensors 15.

When the respective calibration targets 14 are located relative to vehicle 12 and aligned with the sensors of the vehicle 12, a calibration routine is performed whereby the sensor is calibrated using the respective calibration target, which may include running a calibration program and/or performing a test of the calibration of the sensor 15 to confirm its proper operation.

Referring to FIG. 2A, vehicle bay 18 includes a vehicle support platform 22 with a centering system 24 with a forward wheel support and centering assembly 24a and a rearward wheel support and centering assembly 24b upon which vehicle 12 is disposed for positioning or orienting vehicle 12 in the vehicle bay 18. The centering system 24 may be configured to provide an “inside out” centering, where the wheels are pushed outwardly from their inwardly facing sides or an “outside in” centering where the wheels are pushed inwardly from their outwardly facing sides. For details of a suitable centering system, reference is made to U.S. Pat. No. 11,597,091, which is commonly owned by BPG Sales and Technology and is incorporated by reference herein in its entirety, to center the vehicle in the vehicle bay. Further, vehicle bay 18 may use non-contact wheel alignment sensors to facilitate centering of the vehicle 12 in the vehicle bay 18, such as described in the referenced publication.

With reference to FIGS. 2A-2E, forward wheel support and centering assembly 24a includes oppositely disposed tire supports 64a, 64b positioned on opposite sides of forward vehicle centering device 66, where tire supports 64a, 64b are configured to receive the tires of a pair of opposed tire and wheel assemblies of vehicle 12, such as the front tire and wheel assemblies 12a as shown in FIG. 2A (one shown). Tire supports 64a, 64b are substantially identical, but mirror versions of each other. As such, the discussion herein focuses on tire support 64a, but it should be appreciated that the discussion applies to tire support 64b.

Tire support 64a includes two sets 68, 70 of rollers 72 with the rollers 72 arranged with their axes of rotation parallel with the longitudinal axis of the vehicle 12 when disposed on support stand 22. As such, a vehicle having a pair of front tires disposed on rollers 72 will be moveable laterally with respect to its longitudinal axis via the rollers 72. As best shown in FIGS. 2C and 2D, the sets 68, 70 of rollers 72 are inwardly angled with respect to each other. That is, the adjacently located ends of rollers 72 of each set 68, 70 are disposed vertically lower than the outwardly located ends in a V-shaped configuration. As such, the wheel assemblies 12a of vehicle 12 will be naturally oriented to rest in a fixed longitudinal position when located on tire supports 64a, 64b along the axes 74a, 74b defined by the adjacent mounting ends of rollers 72. It should be appreciated that the axes 74a, 74b are arranged so as to be aligned with each other and perpendicular to track 48 and the longitudinal axis of vehicle 12 when positioned on stand 22. Tire support 64a additionally includes ramps 76, 78 for supporting a vehicle tire as the vehicle 34 is driven onto and off of support stand 22.

Vehicle 12 is centered or positioned on support stand 22 in part via vehicle centering device 66, which is operable to center or position the forward portion of vehicle 12. Vehicle centering device 66 includes a pair of opposed synchronized arms or bumpers 80a, 80b that are configured to extend outwardly from housing 82 to contact the inner sidewalls of the tires disposed on tire supports 64a, 64b. Arms 80a, 80b in particular are synchronized to move outwardly from housing 82 equally and simultaneously in opposed directions via a pair of actuators 84a, 84b (FIG. 2E) that are linked together and operated by controller 40. As understood from FIGS. 2D and 2E, arm 84a is affixed to or part of plate 86a and arm 84b is affixed to or part of plate 86b, with plates 86a, 86b being slidably mounted on rails or slides 88, 90. Extendable end 92a of actuator 84a is mounted to plate 86a whereby extension of end 92a causes arm 84a to extend outwardly. Likewise, extendable end 92b of actuator 84b is mounted to plate 86b whereby extension of end 92b causes arm 84b to extend outwardly. The arms 80a, 80b are likewise retractable via retraction of ends 92a, 92b of actuators 84a, 84b. It should thus be appreciated that vehicle centering device 66 is operable to center the forward portion of vehicle 12 on vehicle support stand 22 by way of the rollers 72 allowing the vehicle to be laterally moved via equal and opposite extension of arms 80a, 80b whereby arms 80a, 80b contact and push against the inner sidewall of the tires.

With reference to FIGS. 2B, 2C and 2F, rearward wheel support and centering assembly 24b includes oppositely disposed tire supports 94a, 94b positioned on opposite sides of rearward vehicle centering device 96, where tire supports 94a, 94b are configured to receive the tires of a pair of opposed tire and wheel assemblies of vehicle 12, such as the rear wheel assemblies 12b as shown in FIG. 2A (one shown). Tire supports 94a, 94b are substantially identical, but mirror versions of each other. As such, the discussion herein focuses on tire support 94a, but it should be appreciated that the discussion applies to tire support 94b.

Tire support 94a includes six sets 98a-98f of rollers 100 in the illustrated embodiment, with the rollers 100 arranged with their axes of rotation parallel with the longitudinal axis of the vehicle 12 when disposed on support stand 22. As such, a vehicle having a pair of rear tires disposed on rollers 100 will be moveable laterally with respect to its longitudinal axis via the rollers 100. In contrast to forward wheel support and centering assembly 24a, the rollers 100 of the rearward wheel support and centering assembly 24b all lie in the same plane. The multiple sets 98a-98f of rollers 100 enable vehicles with differing wheelbases to be used on support stand 22. That is, for example, when the opposed forward wheel assemblies of vehicles are retained by tire supports 64a, 64b, the opposed rearward wheel assemblies of the vehicle can still be positioned on tire supports 94a, 94b even with differing wheelbase lengths of the vehicles. Ramps may also be provided at the entrance and exists to tire supports 94a, 94b to aid in the driving of vehicles thereon and off.

Vehicle 12 is also centered or positioned on support stand 22 in part via rearward vehicle centering device 96, which operates in generally like manner to vehicle centering device 66 to center or position the rearward portion of vehicle 12. Rearward vehicle centering device 96 includes multiple pairs of opposed and synchronized locator arms or bumpers 102a, 102b, 104a, 104b and 106a, 106b that are configured to extend outwardly from housing 108 to contact the inner sidewalls of the tires disposed on tire supports 94a, 94b. In particular, each set of opposed arms of centering device 96 are synchronized to move outwardly from housing 108 equally and simultaneously in opposed directions via actuators 110, 112, 114, 116 (FIG. 7) that are linked together and operated by controller 40. Arms 102a, 102b, 104a, 104b, 106a and 106b are slidably mounted for movement on rails or slides 118, 120, 122 and 124, whereby moveable ends 110a, 112a, 114a, 116a of actuators 110, 112, 114, 116 are able to extend and retract arms 102a, 102b, 104a, 104b, 106a and 106b relative to housing 108, including via the pulley linkages 126, 128. It should thus be appreciated that vehicle centering device 96 is operable to center the rearward portion of vehicle 12 on vehicle support stand 22 by way of the rollers 100 allowing the vehicle to be laterally moved via equal and opposite extension of arms 102a, 102b, 104a, 104b, 106a and 106b whereby the arms contact and push against the inner sidewall of the tires.

Although vehicle support stand 22 is shown in the illustrated embodiment to position, center and/or orient the vehicle 12 by arms pushing against the inner sidewall of the tires, it should be readily appreciated that an alternatively constructed centering system could be constructed in which arms or bumpers press against the outer sidewall of the tires by pushing inwardly an equal and opposite amount from the outside of the vehicle, such as inwardly extending locator arms. Moreover, although tire supports 64a, 64b and 94a, 94b of system 10 are disclosed as utilizing rollers 72, 100 for lateral adjustment of vehicle 12 on support stand 22, it should be appreciated that alternative tire supports may be employed within the scope of the present invention. For example, tire supports may be constructed as floating fixtures, such as conventional floating or float plates. Such a floating plate assembly may be recessed into the vehicle support stand and configured to freely float the vehicle wheel assembly on a plate in multiple degrees of freedom, including laterally with respect to the longitudinal axis of the vehicle.

Optionally, vehicle platform 22 includes a pair of ramps 22a to guide the vehicle 12 onto the wheel support and centering assemblies 24a, 24b.

In addition, securement devices, such as wheel chocks or clamps or chains (such as described in reference to FIG. 4) may be provided in the vehicle bay 18, to secure the vehicle 12 on the support platform 22 in the vehicle bay 18. In this manner, when the centering system is deployed, the vehicle will remain stable.

Referring again to FIG. 1, as noted above, vehicle testing and calibration system 10 includes calibration target positioning system 16 and vehicle bay 18, which are both controlled by a computer system or controller 19, which is configured to control the centering and orienting functions, and perform the calibration process, as well as other functions described below. As discussed in more detail below, the computer system 19 may include or comprise a controller, such as a microprocessor based controller, and memory, for processing instructions or for processing an algorithm stored in memory to control operation of calibration target positioning system and the vehicle bay. The controller may comprise one or more microcontrollers, field programmable gate arrays, systems on a chip, discrete circuitry, and/or other suitable hardware, software, or firmware that is capable of carrying out the functions described. In one embodiment, the controller may be configured as a programmable logic controller (PLC) of system 10.

The computer system 19 is configured to acquire vehicle data associated with the vehicle identity of the vehicle 12 and to control the centering system 24 and, further, to detect when the vehicle is aligned and located in its known reference vehicle location. For example, the control system may include sensors, such as distance sensors, including distance sensors configured as time-of-flight (“ToF”) sensors and mounted on the vehicle platform 18 to detect when the vehicle is in its known reference vehicle location. The control system 19 may include a user interface at which an operator may enter the make, model and year and/or the VIN of vehicle 12, or the control system 19 may be configured to automatically detect the vehicle identity of vehicle 12, such as via a vision system integrated with control system 19 or via an electronic data connection with vehicle 12, or an operator may use a device to scan or read data from vehicle 12 into control system 19.

In an initial vehicle setup step, the vehicle 12 enters the vehicle bay 18 and is driven onto the vehicle platform 22 so as to be positioned on the centering device 24. The vehicle 12 may be driven into the vehicle bay 18 by an operator or may be self-driven in the case of an autonomous vehicle. Vehicle information is acquired so as to establish the vehicle identity, which may be input by an operator into the computer system 19 or acquired by the computer system 19 as described above. The vehicle 12 may also be secured on or to the platform 22, such as via chocks. The vehicle 12 may be centered on the vehicle platform.

As noted, the vehicle testing and calibration system 10 may be used to calibrate more than one type of vehicle 12, where the vehicles 12 have different vehicle categories or identities such that the types of sensors and/or sensor locations vary between the vehicles 12. As noted above and described more fully below, the calibration targets 14 may be fixed and located in known fixed target locations and, further, in groups, such as 14a, 14b, with one group for aligning with and calibrating the sensors on one vehicle having one vehicle category and another group for aligning with and calibrating the sensors on another vehicle with another vehicle category so that groups of the calibration targets can be customized to suit different sensor arrangements without moving the calibration targets. Accordingly, the vehicle 12 may be moved within the bay 18 to align the vehicle 12, and thus its accompanying sensors 15, with and/or to the relevant targets 14, such as a particular group of targets 14a or 14b, based on the particular vehicle identity of the vehicle 12 on support platform 22.

In the illustrated embodiment, to move the vehicle 12 in vehicle bay 18, platform 22 may include a turntable 30, which supports the centering system 24 and is used to position the vehicle 12 into a particular vehicle location or orientation by rotating the vehicle 12, such as from a known initial vehicle location or orientation in the vehicle bay 18, where the vehicle 12 is first centered in the bay, to a second orientation that aligns its sensors 15 with the particular group 14a or 14b of calibration targets 14 that are arranged for the sensors 15 on that vehicle 12. It should be understood that system 10 may include multiple groups of targets for calibration of sensors on vehicles from multiple different vehicle categories. Each target group 14a, 14b may include one or more targets for use in calibration of one or more sensors 15 on a given vehicle 12. The turntable 30 may thus be operable to position vehicles by rotation into a plurality of different vehicle orientations, such as based on the vehicle category or identity, in which the sensors 15 of that vehicle 12 are aligned with the relevant group of targets 14 for calibration of those sensors 15. It should be understood that at least for one vehicle category, the known initial vehicle location or orientation may coincide with a target group for that vehicle without the vehicle having to be positioned by rotation of turntable 30. That is, when the turntable 30 is in the initial orientation in which the vehicle 12 is driven onto the platform 22.

With this embodiment the control system 19 may also control the turntable 30. Based on the acquired data of the vehicle 12, the control system 19 adjusts the orientation of the turntable 19 to position the vehicle 12 supported thereon into the vehicle orientation to align the sensors 15 of the vehicle 12 with a group of the calibration targets 14 that are positioned for that vehicle 12. It should be understood that in each vehicle orientation a Cartesian coordinate system of coordinates 0, 0, 0 centered on a fixed reference point, such as centered on the front axle of the vehicle 12, is established with the groups of targets 14 (such as targets 14a) located relative thereto for calibration of the sensors 15 on the vehicle 12. For a vehicle from a different vehicle category or identity, the turntable 30 is rotated into another vehicle orientation in which the Cartesian coordinate system of coordinates 0, 0, 0 centered on a fixed reference point, such as on the front axle of that vehicle in the other vehicle orientation with the groups of targets 14 (such as targets 14b) located relative thereto for calibration of the sensors 15 on that alternative vehicle 12. This is established for each vehicle category. Accordingly, when a vehicle from within a given vehicle category is positioned on platform 22 the turntable 30 rotates the vehicle into the associated vehicle orientation for alignment with the targets for calibration of the sensors on that vehicle.

For example, the turntable 30 may be moved to A degrees off of top dead center for category A vehicles, where top dead center may refer to the initial orientation of the turntable 30 when a vehicle is driven onto platform 22. In this vehicle orientation all of the category A vehicle's calibration targets are positioned for calibration of the sensors on the category A vehicles. The turntable may be selectively moved to B degrees off of top dead center for category B vehicles, whereat all of the category B vehicle's calibration targets are positioned for calibration of sensors on the category B vehicles. It should be appreciated that there may multiple vehicle orientation positions about the 360 degree rotation of the turntable 30, which may only be limited by the space available for targets 14 to be disposed there about. To this end, targets 14 may be supported within bay 18 on or by frames or stands or the like.

Optionally, the turntable may have an angle—or a vehicle orientation position—that is designated as a “flex station” with a set of robots that are configured to position one or more calibration targets in position, such as for a custom set up. In this manner, the test and calibration system 10 is an automated multi-OEM calibration system with high speed and high accuracy and fully upgradeable for future sensor additions. Although discussed above in connection with calibrating vehicle sensors on a vehicle in a single vehicle orientation position based on the vehicle category, it should be appreciated that in an alternative configuration a given vehicle may be rotated into different positions so as to align with different targets for calibration of different sensors at the different positions. For example, a forward facing camera may be calibrated at one position of turntable 30, with turntable 30 being rotated to orient the vehicle into a different orientation to align with a target for calibration of a different sensor on the vehicle.

Once the vehicle set up is complete, that is once the vehicle has been centered on the support platform 22 and the vehicle has been rotated into the vehicle orientation by the turntable 30 for that vehicle, the control system 19 is then configured to perform the calibration process. That is, once the computer system 19 detects that the vehicle 12 is aligned and located in its known reference vehicle location, the computer will initiate the calibration process provided that the vehicle is aligned and located in its known reference vehicle location, and the calibration targets 14 are located in their known reference target locations (and hence aligned with the respective sensors 15 of the vehicle 12), calibration of the sensors 15 may be performed, such as in accordance with OEM specifications.

To this end, an operator may be provided a series of instructions for performing the calibration process via a user interface of the computer system 19, such as a graphical user interface (“GUI”). The instructions may be based on a flow chart that both requests information from the operator regarding the vehicle, such as make, model, year, VIN and/or details regarding equipment of the vehicle, such as tire and wheel size, types of vehicle options, including sensor options, as well as provides information to the operator regarding the system and vehicle setup for calibration of sensors.

As will be more fully described below in reference to yet another embodiment, alternately the calibration target positioning system may be configured to move at least a group of the calibration targets to align with the sensors of the vehicle once the vehicle is aligned and located in a known reference vehicle location. For example, all of the calibration targets 14, or selected calibration targets 14, may be moved in the bay 18 using, for example, robotic arms. Further, the movable calibration targets 14 may be moved in the bay 18 to calibrate sensors on vehicles with different sensor configurations. The calibration targets may be moved instead or in combination with movement of the vehicle. The calibration target positioning system may be configured to move a second group of the calibration targets to align with the sensors of a second vehicle. Further, some of the calibration targets may be fixed calibration targets in fixed known target locations, and other calibration targets may be movable and moved to known reference target locations associated with each vehicle with a different vehicle category to accommodate different sensor locations on different vehicles For further details reference is made to the embodiment described below.

In such an embodiment, the vehicle testing and calibration system includes a calibration target positioning system and vehicle bay for calibrating more than one vehicle, and specifically vehicles having different vehicle categories such that the sensor locations vary between the vehicles.

In the embodiment, the vehicle bay receives a vehicle in the vehicle bay and similarly includes a platform comprising a centering system, such as a centering system 24 as described above, to center the vehicle 12 in the vehicle bay and locate the vehicle 12 in a known reference vehicle location in the vehicle bay. To this end, the vehicle bay includes a plurality of robots configured to hold and position various targets. The robots comprise robots having a fixed base with a multi-axis arm that may position a respective target into a calibration position for a given sensor 15 on a vehicle 12. Preferably the robots are disposed about multiple sides of the vehicle 12 when on the platform, such as at least two of a front side, rear side, and left and right sides of the vehicle 12. Preferably the base of the robots are fixed to the floor. Alternatively, the base may be fixed to a different support, such as an overhead or vertical structure. In particular, the robots are able to grasp a target that is particular to a given sensor 15 of a vehicle 12 and position the target into the proper spatial orientation relative to the vehicle 12 based on the known position of the vehicle on the centering system. It should be appreciated that a plurality of targets may be positioned or stored adjacent the respective robots, with the robots including an end effector or tool configured to selectively grasp the particular target needed for calibration of the sensor 15 of the vehicle 12 under test.

The vehicle bay may also or alternatively use sensors to facilitate centering of the vehicle 12 in the vehicle bay, such as non-contact wheel alignment sensors, such as described in the above referenced patent. In addition, similar to vehicle bay 18, the vehicle bay may include securement devices, such as wheel clamps or chocks to secure the vehicle 12 in the vehicle bay. For further details reference is made above the first embodiment.

As discussed in more detail below, the alternative system includes a computer system, similar to the computer system 19 described above, which is also configured to acquire vehicle data to identify or establish the vehicle category of the vehicle 12 that is located in the vehicle bay. Once a vehicle 12 is centered and located in its known reference vehicle location in the vehicle bay via the centering device, the calibration targets 14 relevant for use with that vehicle 12 are moved to known reference target locations associated with that vehicle (and hence aligned with the respective sensors of that vehicle), so that calibration of the sensors may be performed, such as in accordance with OEM specifications.

Further, the calibration target positioning system may move just a group of the calibration targets based on the vehicle category of the vehicle 12 so that the group of calibration targets are aligned with the sensors 15 of the vehicle once the vehicle 12 is aligned and located in its known reference vehicle location in the vehicle bay.

Therefore, the calibration targets are moved to known reference target locations to align with the sensors of the vehicle based on the vehicle category of the vehicle. Upon aligning the selected calibration targets relative to vehicle 12, and hence with the sensors of the vehicle 12, a calibration routine is performed whereby the sensors are calibrated using the respective calibration target.

Alternately, some of the calibration targets may be fixed in a fixed known target locations and the other calibration targets 114 may be movable.

In the embodiment the movable calibration targets may be mounted on robot arms of the robots. The actuators of the robotic arms may be controlled by on board controllers that are then controlled by the control system or may be directly controlled by the control system. It should be appreciated that alternative arrangements of moving the respective calibration targets made be used. For example, one or more calibration targets may be mounted to frames that are fixed to the floor with the frames having one or more articulating members that are controlled by one or more actuators to move the respective calibration targets. Again the actuators may be controlled by onboard controller that are then controlled by the control system or may be directly controlled by the control system. For example, with reference to U.S. Pat. No. 11,624,608, which is incorporated herein by reference, rather than use of a moveable base, a plurality of frames that are fixed to the floor may be disposed about the vehicle platform, with the frame including a moveable target holder that may be moved in three axis as well as rotated about a vertical axis.

In an initial vehicle setup step, vehicle 12 may be moved in the vehicle bay by a driver or may be autonomously moved (e.g., when the vehicle is an autonomous vehicle). Once the vehicle is at least located in the bay, the vehicle category information may be determined by the control system or input into the control system by an operator, such as by input into a desktop, laptop or tablet, or may be obtained directly from a computer of vehicle 12, such as an electronic control unit (ECU) of vehicle 12. For examples of suitable vehicle category information, reference is made to the previous embodiment.

Similar to the previous embodiments, the fixed reference point on the vehicle is the center of the front axle. Therefore, once the vehicle is centered in the fixed position, the computer system may use the center of the front axle as the center of a Cartesian coordinate system, which is used by the computer system as the known reference vehicle location of the vehicle 12 and therefore the location of the sensors 15 on the vehicle 12. Further, based on this Cartesian coordinate system and the vehicle information, the computer system determines the known reference target locations for the group of calibration targets and then moves the respective targets to the known reference target locations for the vehicle 12 located in the vehicle bay. Once the vehicle and calibration targets set up is complete, the control system is configured to perform the calibration process.

For a discussion of other features and functions that may be provided by the control system, reference is made to the above embodiment.

In any of the above systems, a camera or cameras may be provided to take images of the vehicle to document the calibration setup of the vehicle and/or targets. The images taken by the cameras may be transmitted to the control system, and may also used by the control system, in some embodiments to establish a proper orientation for the calibration targets.

The vehicle sensors may vary and include sensors that are part of one or more subsystems of an Advanced Driver Assistance System (ADAS) of the vehicle. The sensors thus may be radar sensors for adaptive cruise control (“ACC”), imaging systems such as camera sensors for lane departure warning (“LDW”) and other ADAS camera sensors disposed about vehicle, as well as other sensors, such as LIDAR, ultrasonic, and infrared (“IR”) sensors of an ADAS system, including sensors mounted inside the vehicle, such as forward facing cameras, or exterior mounted sensors.

The calibration system may be disposed within a repair facility having multiple bays for calibrating sensor on multiple vehicles-either each vehicle bay uniquely configured for one category or vehicle, and another bay uniquely configured for another category or vehicle. Optionally, as illustrated in FIG. 1, each vehicle bay may be located in an enclosure with an access door D. Further, the testing and calibration systems may include other testing equipment as noted below.

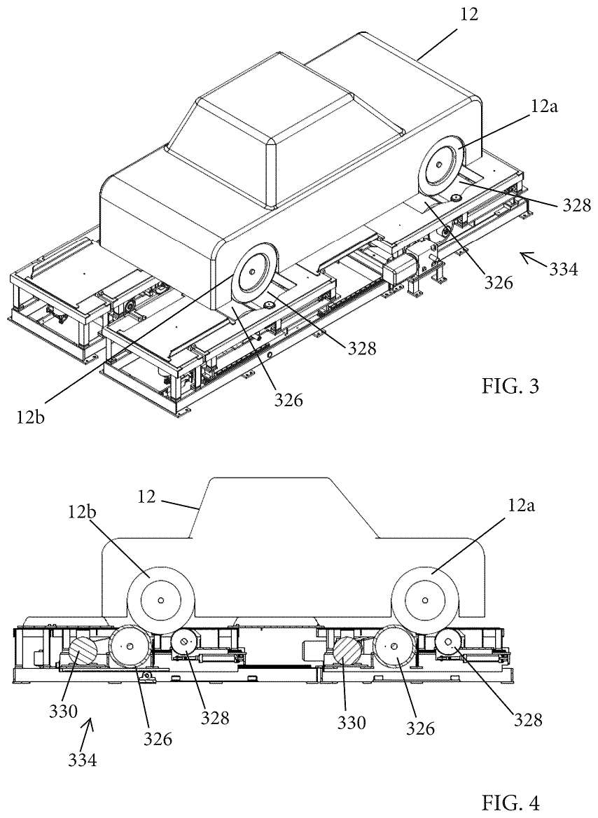

Referring to FIGS. 3 and 4, in any of the above systems, the vehicle platform 22 may include a dynamic vehicle testing apparatus or stand 324 in place of the centering system 24 described above, including optionally in combination with the turntable 30, and where the dynamic vehicle testing apparatus 324 may incorporate an “outside in” centering system that includes pushers that push against the vehicle inwardly from the outwardly facing sides to center the vehicle on the stand 324. For example, arms or extensions may be extended inwardly toward the vehicle from either side of the vehicle to contact portions or areas or locations on the vehicle, such as on the body, chassis frame or wheel assemblies.

As understood from FIGS. 3 and 4, dynamic vehicle testing apparatus 324 is configured as a roll-brake stand having pairs of rollers 326, 328 that rotationally support front and rear tire and wheel assemblies 12a, 12b of vehicle 12. Vehicle 12 is configured to be operated on apparatus 324 such that the vehicle powertrain drives one or more of rollers 326, 328, where the rollers 326, 328 may provide rolling resistance to the driven wheels 12a, 12b of vehicle 12 strictly via inertial resistance. Alternatively, electric motors 330 coupled with rollers 326, 328 may be employed to provide additional resistance to driven wheels of vehicle 12. Although apparatus 324 may have four pairs of rollers 326, 328 for each of the wheel assemblies 12a,12b of vehicle 12, it should be appreciated that an alternatively configured apparatus may have fewer such pairs of rollers, such as two forward sets for a front wheel drive vehicle. It should further be appreciated that alternatively configured and arranged roll brake stands or dynamometers may be employed. For further details of apparatus 324, reference is made to test stand 24 in copending commonly owned U.S. patent application Ser. No. 18/760,366, which was filed on Jul. 1, 2024, and which is incorporated by reference in its entirety herein.

In this manner, the vehicle 12 can be dynamically operated on the stand 324 as part of the testing and calibration system, such as while establishing a known position of the vehicle 12 on the stand 324, such as establishing a Cartesian coordinate system with the center of the front axle as the 0, 0, 0 origin. In particular, in accordance with this arrangement dynamic ADAS systems may be operated without an On-Board Diagnostics connection, such as an OBDII connection, while the vehicle is in the known position. This can aid in the testing and calibration of the ADAS systems, including such systems that may not otherwise operate in a normal driving setting when a diagnostic tool or other device is connected to the OBD connector port of the vehicle. Moreover, the vehicle 12 can be “steered” on the stand 324 for the testing or calibration of sensors. That is, the steering wheel may be turned in which case the vehicle 12 may be allowed to move longitudinally on the stand 324, or may alternatively be kept in place on the stand 324 by the centering system. Still further, the rollers of stand 324 may be configured so as to be pivotable about one or more vertical axes relative to the longitudinal length of the stand 324. It should be further appreciated that stand 324 may be disposed on or as part of a turn table to allow the stand 324 to be rotated into alternative orientations, such as for use in testing or calibrating ADAS sensors and systems of an alternative make and/or model vehicle 12, as discussed above.

Further changes and modifications in the specifically described embodiments can be carried out without departing from the principles of the present invention which is intended to be limited only by the scope of the appended claims, as interpreted according to the principles of patent law including the doctrine of equivalents.

We claim:

1. A vehicle testing and calibration system for calibrating sensors on equipped vehicles, the system comprising:
at least one calibration target that is arranged in a defined space at a known fixed target location;
a vehicle platform for receiving a vehicle equipped with at least one sensor and having a vehicle category, the vehicle category defining the locations of the at least one sensor on the vehicle, and the vehicle having a vehicle category reference position associated therewith, wherein the vehicle platform is configured to orient the vehicle into the vehicle category reference position; and
the known fixed target location being based on the vehicle category wherein when the vehicle is oriented in the vehicle category reference position the at least one calibration target is aligned with the at least one sensor of the vehicle for calibration of the at least one sensor of the vehicle.

2. The system of claim 1, wherein the system comprises a plurality of targets that are each arranged in the defined space at known fixed target locations and wherein the vehicle platform is configured to individually orient a plurality of vehicles having different vehicle categories and that each include at least one sensor into different vehicle category reference positions associated with each vehicle category, and wherein when a selected vehicle of each vehicle category is oriented into its associated vehicle category reference position at least one of the targets is aligned with at least one sensor on the selected vehicle for calibration of the at least one sensor on the selected vehicle.

3. The vehicle system of claim 2, wherein the vehicle platform comprises a turntable that is rotatable to rotate vehicles disposed on the vehicle platform about a vertical axis, and wherein the turntable is configured to rotate to orient individual vehicles into the associated vehicle category reference position associated with vehicle.

4. The system of claim 3, wherein the vehicle platform further comprises a vehicle centering device disposed on the turntable, wherein the vehicle centering device is configured to align vehicles into a known location on the vehicle platform.

5. The system of claim 1, wherein the vehicle is equipped with a plurality of sensors and wherein the system comprises a plurality of calibration targets that are arranged in the defined space at known fixed target locations, wherein when the vehicle is oriented in the known reference vehicle position the plurality of calibration targets are aligned with the plurality of sensors of the vehicle for calibration of the plurality of sensors of the vehicle.

6. The system of claim 5, wherein the vehicle platform is configured to individually orient a plurality of vehicles having different vehicle categories and that each include a plurality of sensors into different vehicle category reference positions associated with each vehicle category, and wherein when a selected vehicle of each vehicle category is oriented into its associated vehicle category reference position a group of the plurality of targets are aligned with the plurality of sensors on the selected vehicle for calibration of the plurality of sensors on the selected vehicle.

7. The system of claim 6, wherein the plurality of targets comprise a plurality of groups of targets, and wherein each group of targets is associated with a separate vehicle category.

8. The system of claim 7, wherein the vehicle platform comprises a turntable that is rotatable to rotate vehicles disposed on the vehicle platform about a vertical axis, and wherein the turntable is configured to rotate to orient individual vehicles into the associated vehicle category reference position associated with vehicle.

9. The system of claim 8, wherein the vehicle platform further comprises a vehicle centering device disposed on the turntable, wherein the vehicle centering device is configured to align vehicles into a known location on the vehicle platform.

10. A vehicle testing and calibration system for calibrating sensors on equipped vehicles, the system comprising:
a vehicle platform for receiving an individual vehicle equipped with at least one sensor and having a vehicle category, the vehicle category defining the locations of the at least one sensor on the vehicle, wherein the vehicle platform comprises a vehicle centering device and a turntable and is configured to orient the vehicle into a reference position;
a plurality of targets that are each arranged in a defined space at fixed known target locations about the vehicle platform and wherein the vehicle platform is configured to individually orient a plurality of vehicles having different vehicle categories and that each include at least one sensor into different reference positions associated with each vehicle category, and wherein when a selected vehicle of each vehicle category is oriented into its associated reference position at least one of the targets is aligned with at least one sensor on the selected vehicle for calibration of the at least one sensor on the selected vehicle
wherein the known target locations are based on the vehicle category wherein when the vehicle is oriented in the reference position at least one of the targets is aligned with the at least one sensor of the vehicle for calibration of the at least one sensor of the vehicle.

11. The system of claim 10, wherein the system is configured to orient vehicles from at least one vehicle category having a plurality of sensors into the reference position for that vehicle category, and wherein when the vehicle with a plurality of sensors is in the reference position a plurality of targets are aligned with the plurality of sensors for calibration of the plurality of sensors.

12. The system of claim 10, wherein the plurality of targets comprise a plurality of groups of targets, and wherein each group of targets is associated with a separate vehicle category.

13. The system of claim 10, wherein the centering device comprises a forward centering device for receiving forward wheel assemblies of the vehicle and a rearward centering device for receiving rear wheel assemblies of a the vehicle.

14. The system of claim 10, wherein the turntable is configured to rotate the vehicle when the vehicle is disposed on the centering device.

15. The system of claim 10, wherein the defined space comprises a vehicle bay into which the vehicle is drivable onto the centering device.

16. The system of claim 10, wherein the vehicle platform comprises a dynamic vehicle platform on which tire and wheel assemblies of the vehicle may be operated to simulate the vehicle driving.

17. A method of testing and calibrating sensors on equipped vehicles, said method comprising:
providing a plurality of targets for calibration of sensors of equipped vehicles from a plurality of vehicle categories, wherein each vehicle category defines locations of at least one sensor on a vehicle of the vehicle category;
orienting a vehicle into a reference position on a vehicle platform;
moving the vehicle based on the vehicle category of the oriented vehicle to align the plurality of targets with the sensors for calibrating the sensors.

18. The method of claim 17, wherein the vehicle platform comprises a centering device for orienting the vehicle into the reference position.

19. The method of claim 18, wherein said moving the vehicle comprises rotating the vehicle on the vehicle platform.

20. The method of claim 19, wherein the vehicle platform comprises a turntable on which the centering device is disposed.
